(19) United States
(12) Patent Application Publication
(10) Pub. No.: US 2004/0194021 A1
(43) Pub. Date: Sep. 30, 2004

(54) Systems and methods for sharing high value annotations

(75) Inventors: Catherine C. Marshall, San Francisco, CA (US); Morgan N. Price, Lafayette, CA (US); William N. Schilit, Menlo Park, CA (US); Gene Golovchinsky, Palo Alto, CA (US); Frank M. Shipman III, College Station, TX (US); Kei Tanaka, Hiratsuka (JP)

Correspondence Address: OLIFF & BERRIDGE, PLC, P.O. BOX 19928, ALEXANDRIA, VA, 22320, US

(73) Assignee: Fuji Xerox Co., LTD., Tokyo (JP)

(21) Appl. No.: 09/951,733

(22) Filed: Sep. 14, 2001

(51) Int. Cl. G06F 17/24

(52) U.S. Cl. 715/512

(57) ABSTRACT

Techniques are provided for displaying sets of high value annotation information while maintaining the contextual relevance of the high value annotations to the source portion of the annotated document. A selection criteria such as annotator name, time or other criteria, is applied to the high value annotations. High value annotations having overlapping display locations in the source document are determined and the overlap resolved based on a presentation style. The high value annotations and the document is displayed based on the presentation style.

### BACKGROUND OF THE INVENTION

1. Field of Invention

This invention relates to managing and using high value information.

2. Description of Related Art

Annotation techniques provide users the ability to attach information to a document. For example, a conventional text book user may use ink to write a note in the margin of a text book relating to the adjacent paragraph of the text. A conventional text may be highlighted to indicate passages of importance. Written notes or marks entered in the margin may be used to capture user's thoughts about the paragraph. However, these marks or annotations are usually of value only to the original user since only the original user is able to differentiate the high value annotations from the low value annotations. Also, later users of the text may find it difficult to apply their own annotations to a previously annotated text. Later users of the text would also find it difficult to differentiate between the annotations of multiple prior users.

Conventional electronic annotation and collaborative commentary systems have attempted to address some of these problems. For example, Hardock's MATE system Hardock et al, “A Marking Based Interface for Collaborative Writing”) in Proceeding of UIST' 93, 1993 p. 259-266. The Hardock system uses color to display annotations in user-controllable layers. However, simultaneous display of multiple user's annotations is limited by the overlapping of annotation information. Also the Hardock system requires a user to review all the and does not differentiate the value of annotations, resulting in overlapping annotations among the different users.

Some other conventional systems, such as Shardanand's Ringo system Shardanand et al., “Social Information Filtering: Algorithms for Automating ‘Word of Mouth’ in Proceedings of CHI '95 Denver, Colo. May 7-11, 1995 and Hill's Bellcore video rating system, Hill et al, Recommending and Evaluating Choices in a Virtual Community of Use, in Proceedings of CHI '95, Denver, Colo., May 7-11, 1995, require readers to assign ratings or intentionally evaluate materials for other readers. Thus these conventional systems fail to make use of information an annotating user readily makes available during the reading process.

### SUMMARY OF THE INVENTION

Systems and methods that make use of annotation information generated by a user during the reading process would be useful. Also systems and methods that provide for sharing determined high value annotations while maintaining the contextual relevance to the associated portion of a document would also be useful. The systems and methods according to this invention provide for sharing determined high value annotations. The systems and methods according to this invention also provide for detecting high value annotations and combining the high value annotations based on criteria such as value, within the context of a document. In various exemplary embodiments according to this invention, the annotations associated with a portion of text in a document are determined. The annotations may include annotations from multiple users or a single user over a period of time.

The annotations are analyzed to determine the high value annotations. High value annotations may be determined based on an annotation scheme, an objective indicator of value, a standard indicator of value or any other known or later developed method of determining high value. A presentation style for the annotations is selected. The presentation style may include selective overlay of high value annotations, emphasis iconification of high value annotations, selective re-scaling and/or re-positioning of the annotations or any other type of display processing that preserves the associated contextual relevance between the high value annotations and the associated portion of text in the document.

The high value annotations may be determined by analyzing freeform annotated printed documents entered into the system or high value annotations may be recorded and/or entered separately using any type of entry or processing.

### BRIEF DESCRIPTION OF THE DRAWINGS

Various exemplary embodiments of this invention will be described in detail, with reference to the following figures, wherein:

FIG. 1 shows an exemplary embodiment of a system for sharing high value information according to this invention;

FIG. 2 shows in greater detail a first exemplary embodiment of a system for sharing high value information according to this invention;

FIGS. 3A-B shows a flowchart outlining an exemplary embodiment of a system for sharing high value information according to this invention;

FIGS. 4A-B shows a first and second exemplary high value annotations;

FIG. 5 shows high value annotations and associated portions of text of a document according to an exemplary embodiment of this invention;

FIG. 6 shows a high value annotation and a document displayed according to an exemplary embodiment of this invention;

FIG. 7 shows a display of a high value annotation and a document according to an exemplary embodiment of this invention;

FIG. 8 shows a first document displayed according to this invention;

FIG. 9 shows a second document displayed according to this invention;

FIG. 10 shows a third document displayed according to this invention.

### DETAILED DESCRIPTION OF EXEMPLARY EMBODIMENTS

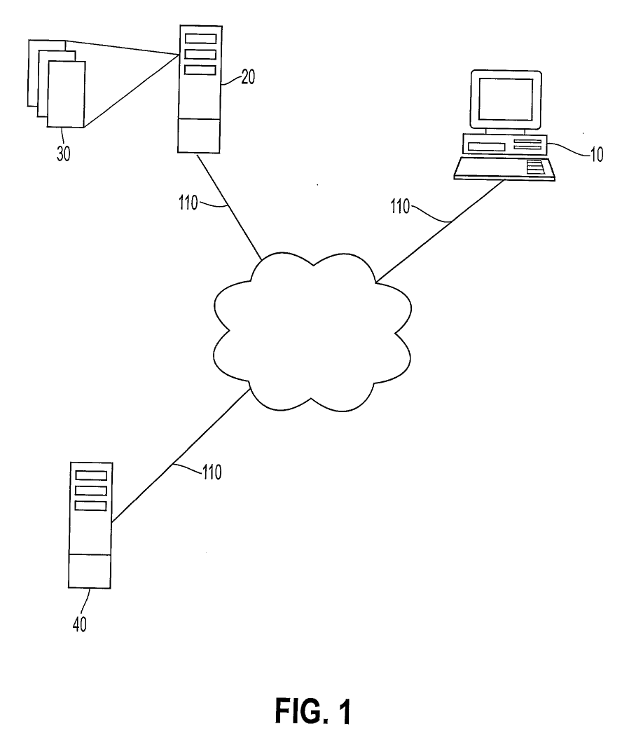

FIG. 1 shows an exemplary embodiment of a system for sharing high value annotations 40 according to this invention. A communications link 110 connects an access device 10 to a system for sharing high value annotations 40 and to a document repository 20 providing access to documents 30.

A user request for selected high value annotations of a portion of a document 30 is sent by access device 10 to the system for sharing high value information 40. The access device 10 may be a personal computer, a web-enabled phone, a web-enabled personal digital assistant, a voice enabled access device or any other device capable of providing access to a document.

In a first exemplary embodiment according to this invention, the system for sharing high value information 40 retrieves the requested document 30 from document repository 20. The document repository 20 may be provided by a document repository 20, a web server, a digital library manager or any other means of providing access to the information without departing from the spirit or scope of this invention.

The system for sharing high value annotations 40 retrieves annotations based on user specified selection criteria, predetermined criteria or any other selection criteria. A presentation style is retrieved and/or input by a user and the selected annotations and document are displayed based on the presentation style.

It will be apparent that the system for sharing high value information 40 is shown separately from the document repository 20 merely for discussion purposes. The system for sharing high value information 40 may be located with the access device 10, within the document repository 20 or at any other location accessible over communication link 110 without departing from the spirit or scope of this invention. It will also be apparent that in various other exemplary embodiments according to this invention, the document 30 may be located within access device 10 or at any location accessible over communication link 110.

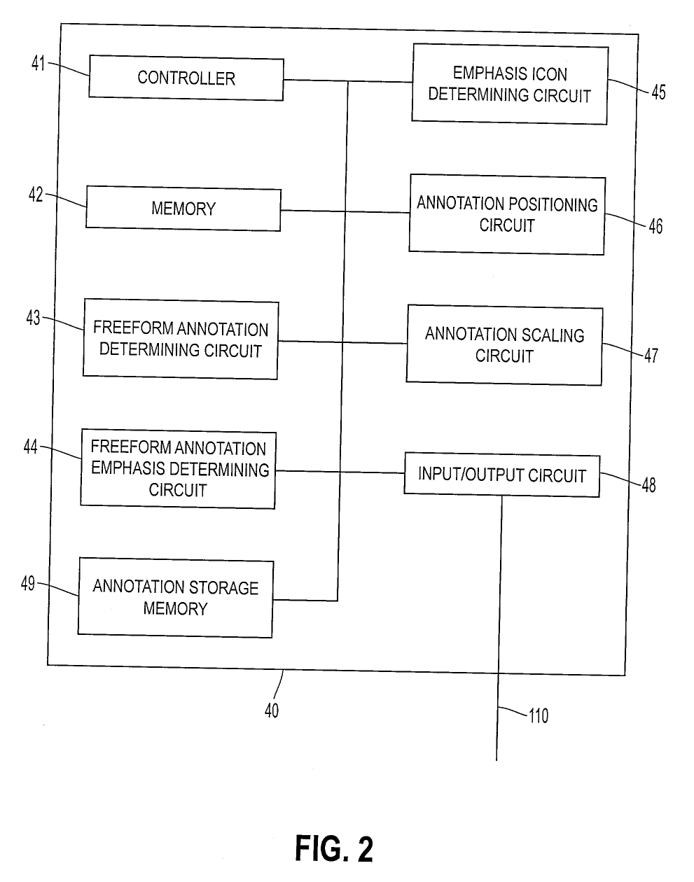

FIG. 2 shows in greater detail a first exemplary embodiment of a system for sharing high value information according to this invention.

In one exemplary embodiment, the system for sharing high value annotations 40 includes a controller 41 memory 42, a freeform annotation determining circuit 43, a freeform annotation emphasis determining circuit 44, an emphasis icon determining circuit 45, an annotation positioning circuit, an annotation scaling circuit 47, an annotation storage memory 49 each connected to communication link 110 via input/output circuit 48.

The controller 41 retrieves a document 30 from a document repository 20 over communications link 110 and stores the document in memory 42. However, in various other exemplary embodiments according to this invention, the document may be stored in memory 42 or any location accessible via communication link 110.

The freeform annotation determining circuit 43 is activated to determine annotations of the stored document. The free form annotation circuit 43 may determine annotations that exist on a document image using any of the systems and methods discussed in Cass, U.S. Pat. No. 5,692,073 incorporated herein by reference in its entirety. Alternatively, previously entered high value annotations may be retrieved from a high value annotation store, or any other known or later developed method of determining annotations may be used.

The determined free-form annotations are then stored into the annotation storage memory 49. However, it will be apparent that any high value annotations previously determined, entered or designated using any other known or later developed method may be saved into annotation storage memory 49.

The controller 41 activates the freeform annotation emphasis determining circuit 44 to determine the high value annotations. For example, the freeform annotation emphasis circuit 44 may determine high value annotations based on the methods discussed in co-pending, co-assigned Application entitled “Systems and Methods for Automatic Emphasis of Freeform Annotations”, Attorney Docket 110014, or any other known or later developed method of determining high value annotations.

The controller 41 determines a presentation style. The presentation style may be input by the user and received by the input/output circuit 48 or may be previously stored in memory 42. If the determined presentation style is selective a overlay presentation style, the controller 41 selects the high value annotations to be displayed.

For example, the high value annotations may be selected based on ser identifier, time, group identifier, ranked importance or any other known or later developed method of selection. Any overlap between the position of the selected high value annotations in the document is determined. For example, a document containing two high value annotations in the same position in the document would be difficult to read due to the overlapping high value annotations. The controller 41 identifies overlapping annotations. The annotation scaling circuit 47 is activated to scale the high value annotations and the annotation positioning circuit 46 is activated to re-position high value annotations while maintaining the contextual relevance with the associated portion of the document.

Similarly, if the presentation style is an emphasis icon presentation style, the controller 41 activates the emphasis icon determining circuit 45.

The emphasis icon determining circuit 45 determines an emphasis icon to indicate high value annotations in a compact form. In various exemplary embodiments according to this invention, the emphasis icon may be an asterisk or any other type of displayable character or element. Multiple emphasis icons and or displayable characters or elements may be used to indicate importance, different users, time of annotation or any other attribute or feature of the annotations. For example, high value annotations of multiple users may be indicated by bars in the margin adjacent to portions of the document relevant to the high value annotations. The identity of each user may be indicated by a double, triple or other number of bars, emphasis icons or display elements.

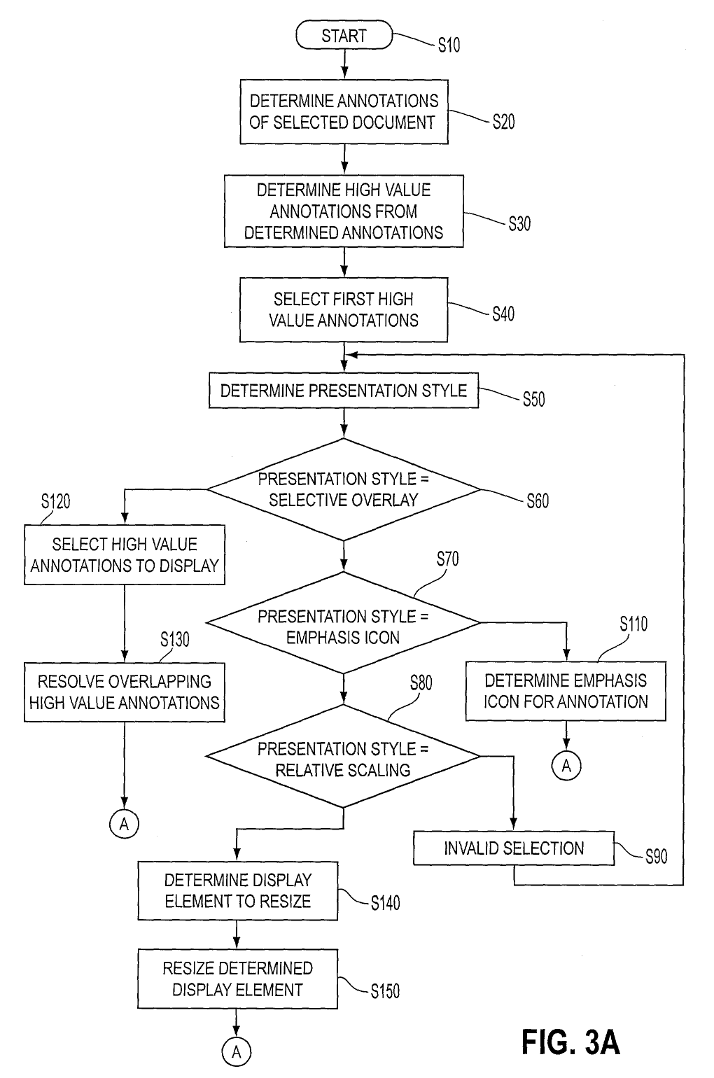

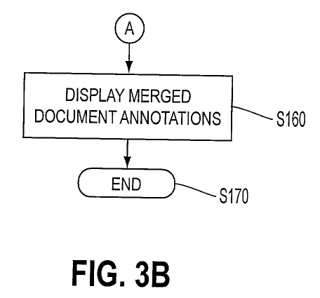

FIGS. 3A-B shows a flowchart outlining an exemplary embodiment of a system for sharing high value annotations 40 according to this invention. Control begins at step S10 and immediately continues to step S20.

In step S20, the determined annotations associated with the document are selected. For example, the determined annotations may be selected based on the name of the annotator, the annotators membership in a group such as an instructor group. Alternatively, the selection may be based on time, such as most recent annotation or any other known or later developed attribute or feature of the annotation. After the annotations have been selected, control continues to step S30.

In step S30, the high value annotations are determined. The high value annotations may be determined using any known or later developed methods or techniques. For example, determining the high value annotations may be based on a users annotation rank codes or may be determined based on statistical analysis of importance, past annotation practice or may use any of the methods discussed in co-pending, co-assigned Application entitled, “Automatic Emphasis of Freeform Annotations”, Attorney Docket Number 110014, Ser. No. 09/XXX,XXX, incorporated herein by reference in its entirety. After the high value annotations have been determined, control continues to step S40.

In step S40 a first high value annotation is selected for processing and control continues to step S50. In step S50, the presentation style of the high value annotation is determined. The presentation style of the high value annotations may be determined by reading an input value from the user, reading a memory location for a pre-stored presentation style or any other known or later developed method of determining the presentation style. Control continues based on the presentation style. For example, the user may select a selective overlay presentation style, an emphasis icon presentation style, a relative scaling presentation style or any other known or later developed technique of presenting annotations that maintains the contextual relevance between the annotations and the associated portion of the document. Control continues to step S60.

In step S60 a determination is made as to whether the selective overlay style of presentation has been selected. If the selective overlay presentation style was not selected control continues to step S70, otherwise, control continues to step S120.

High value annotations are selected in step S120. For example, the user may request to see all high value annotations associated with the instructors for a course. Alternatively, a student user may request to see all high value annotations produced by all fellow classmates or merely selected classmates. In various alternative embodiments according to this invention, the determination of high value annotations to be displayed may be based time, relative rank or value, frequency of citation by other users or any other known or later developed attribute or feature of the high value annotations. Control then continues to step S130.

In step S130, any overlapping high value annotations are resolved or separated. Overlapping high value annotations are likely to occur when the high value annotations of several users are selected for display. For example, when several different users place high value annotations in the same margin location or when several users highlight the same portion of the document, the information associated with overlapping annotations are difficult to understand and may obscure the associated portions of the document.

The overlapping annotations are therefore analyzed. In various exemplary embodiments according to this invention, the individual annotations each have display windows. The annotation display windows are analyzed and the location of the high value annotation display windows are adjusted to separate and re-scale the high value annotations while maintaining each high value annotations contextual relevance to the associated portion of the document. Control continues to step 160 where the document and high value annotations are displayed. Control continues to step S170 and the process ends.

If the determination is made at step S60 that the presentation style was not a selective overlay presentation style, then control continues to step S70.

In step 70, a determination is made as to whether an emphasis icon presentation style was selected. If an emphasis icon presentation style was selected control continues to step S110, otherwise, control continues to step S80.

In step S110 emphasis icons for high value annotations are determined. For example, emphasis icons may include an asterisk to indicate a portion of the document of particular relevance. Multiple emphasis icons may be displayed adjacent to each other to indicate the number times the portion of the document was annotated by other users or groups of users. In various other exemplary embodiments according to this invention, color, size, font or any other display attribute may be used to indicate the annotation author, time relevance of the annotation or any other known or later developed attribute or feature associated with the high value annotations. Control continues to step 160 where the document and high value annotations are displayed. After displaying the document and annotations, control continues to step S170 and the process ends. Alternatively, a new document or presentation style may be desired in which case, control continues to step S10 and the process begins again.

In step S80, a determination is made whether a relative scaling presentation style was selected. If it is determined that a relative scaling presentation style was not selected, control continues to step 90 where an error message is displayed. The error messages indicates that an invalid presentation style was selected. Control then jumps to step S50 where a new presentation style may be determined and steps S60-S80 are repeated. Alternatively, in various other exemplary embodiments, processing may end when an invalid presentation style is selected. If it is determined in step S80 that the presentation style is a relative scaling presentation style, then control continues to step S140.

A display element such as a high value annotation or a portion of the document is determined in step S140. For example, the user may select high value annotations to be the focus of attention. This might be used to provide a discussion outline for the document in a collaborative setting such as a meeting or seminar. Alternatively, the document may be selected as the display element. Control continues to step S150.

In step S150 the determined display element is re-sized. For example, a high value annotation may be re-sized to increase the size of the high value annotation relative to the contextually relevant portion of the document. In this way the user's focus of attention may be directed more quickly to the information presented in the high value annotation. The user may then glance at the reduced or re-sized contextually relevant portion of the document to gain context for the annotation commentary. This allows the user to focus more quickly more quickly on the high value information.

Similarly the document may be selected if a user would like to read a portion of the document without the distraction presented by large number of high value annotations while maintaining cues as to the high value portions of the document. Once the determined display element is re-sized, control continues to step S160.

In step S160, the annotations and document are displayed based on the selective overlay, emphasis icon or relative scaling presentation style. The display may be a printed output such as a paper copy of the high value annotations and associated document or the high value annotations and associated document may be displayed on a computer display, a television, or any other known or later developed method of display. Control then continues to step S170 where the process ends.

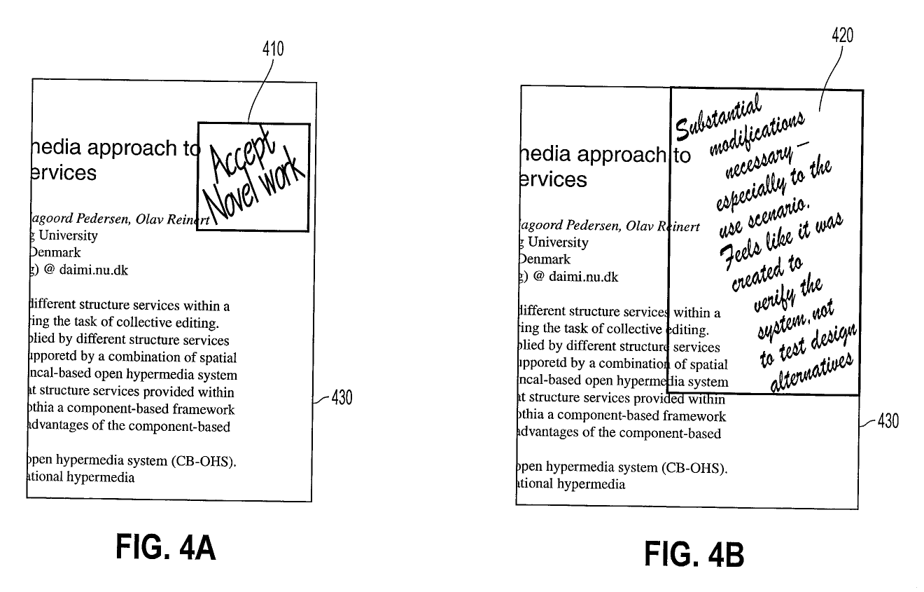

FIGS. 4a-b show first and second exemplary high value annotations. The first user's high value annotation 410 is shown within a first box indicating the space occupied by the high value annotation 410 in document 430. A second user's high value annotation 420 is shown within a second box indicating the space occupied by the high value annotation 420 in document 430. If a third user attempts to view the contextually relevant portions of the document and both the first user's high value annotation 410 and a second user's high value annotations 420, the overlapping of the high value annotations will render the result un-readable. It will be apparent that these problems are increased as the number of different user annotators increases.

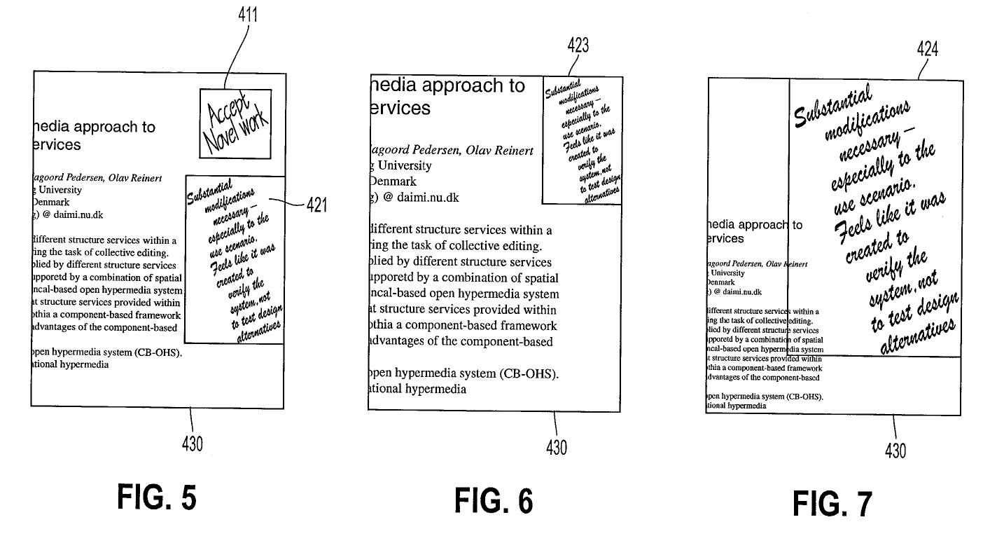

FIG. 5 shows high value annotations and associated portions of text of a document according to an exemplary embodiment of this invention. The first user's high value annotation 410 of FIG. 4a, is re-scaled and/or re-positioned as a first re-scaled high value annotation 411. Similarly the second user's high value annotation 420 of FIG. 4b, is re-scaled and/or re-positioned as a second re-scaled high value annotation 421. In the first exemplary embodiment according to this invention, the first re-scaled high value annotation 411 and second re-scaled high value annotation 421 are re-scaled so that both are displayed adjacent to the contextually relevant portion of the document. However, it will be apparent that in various other exemplary embodiments according to this invention, any process such as morphing the high value annotations to change the aspect ratio, re-positioning of the high value annotations to provide more room or to emphasize relevance or any other known or later developed method for modifying the high value annotations may be used without departing from the spirit or scope of this invention.

FIG. 6 shows a high value annotation and document displayed according to a first exemplary embodiment of this invention. The second user's high value annotation 420 has been re-scaled to reduce the size of the high value annotation and re-positioned to create a second re-scaled re-positioned annotation 423 in the upper right corner of the document 430. This process may be used for example, to increase space in the document for additional annotations.

FIG. 7 shows a high value annotation and an document displayed according to an exemplary embodiment of this invention. The second user's high value annotation 420 is re-scaled to increase the size of the high value annotation. The size of the text of document 430 is reduced. This process places the second re-scaled high value annotation more prominently within the user's focus of attention while maintaining the contextual relevance with the associated portion of document 430.

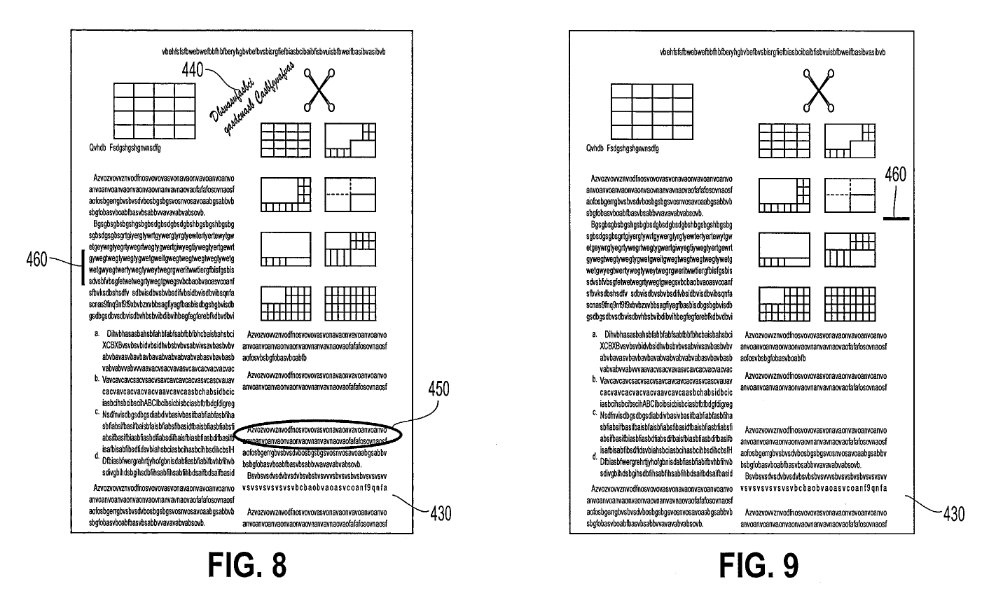

FIG. 8 shows a first document displayed according to this invention. A third user's high value annotation 440 is a margin note. A fourth user's high value annotation 450 is a circle mark. A fifth user's high value annotation 460 is a bar in the margin indicating a portion of the document to which attention is to be drawn. Display characteristics of each high value annotation such as ink color, background color or other characteristic may be determined based on attributes of the annotation such as user identification, time of annotation, importance of annotation or any other known or later developed annotation attribute.

FIG. 9 shows a second exemplary document displayed according to this invention. A document 430 contains high value annotation 460. The high value annotation 460 in document 430 is displayed with an emphasis icon style of presentation. Three consecutive asterisks are displayed adjacent to a figure (in the second column) in document 430. The multiple asterisks may be used to indicate the relative importance of the high value annotation 460. In various exemplary embodiments according to this invention, a cursor may be rolled over the emphasis icon to activate a pop-up dialog box, a balloon dialog box or any other type of message indicator to display the text of the high value annotation 460.

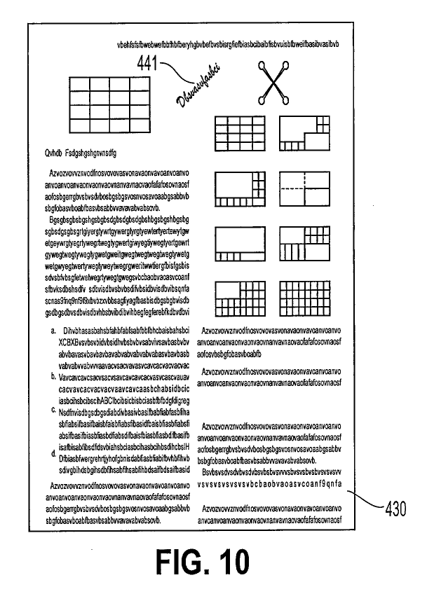

FIG. 10 shows a second exemplary document displayed according to this invention. Document 430 contains multiple sets of high value annotations. The high value annotation 441 has been scaled and re-positioned relative to the other high value annotations to allow for a simultaneous display of the multiple sets of high value annotations.

It will be apparent that in various other exemplary embodiments according to this invention the document may be a paper document, an electronic document or any other known or later developed type of document. Annotation of portions of the document may be made using a physical ink on a document and the resulting document analyzed to determine the high value annotations. In various alternative embodiments, highlighting of selected portions of the document text, digital ink marks and/or gestures or motions using an ink or digital indicator may be used to enter high value annotations without departing from the spirit or scope of this invention.

In the various exemplary embodiments outlined above, the system for sharing high value information 40 can be implemented using a programmed general 5 purpose computer. However, the system for sharing high value information 40 can also be implemented using a special purpose computer, a programmed microprocessor or micro-controller and peripheral integrated circuit elements, an ASIC or other integrated circuit, a digital signal processor, a hardwired electronic or logic circuit such as a discrete element circuit, a programmable logic device such as a PLD, PLA, FPGA or PAL, or the like. In general, any device, capable of implementing a finite state machine that is in turn capable of implementing the flowchart shown in FIG. 3A-3B, can be used to implement the system for sharing high value information 40.

Each of the circuits or software routine or elements 41-49 of the various exemplary embodiments of the system for sharing high value information 40 outlined above can be implemented as portions of a suitably programmed general purpose computer. Alternatively, each of circuits or software routine or elements 41-49 of the various exemplary embodiments of the system for sharing high value information 40 outlined above can be implemented as physically distinct hardware circuits within an ASIC, or using a FPGA, a PDL, a PLA or a PAL, or using discrete logic elements or discrete circuit elements. The particular form each of the circuits or software routine or elements 41-49 of the various exemplary embodiments of the system for sharing high value information 40 outlined above will take is a design choice and will be obvious and predicable to those skilled in the art.

Moreover, the various exemplary embodiments of the system for sharing high value information 40 and/or each of the various circuits or software routines or elements discussed above can each be implemented as software routines, managers or objects executing on a programmed general purpose computer, a special purpose computer, a microprocessor or the like. In this case, the various exemplary embodiments of the system for sharing high value information 40 and/or each of the various circuits or software routine or elements discussed above can each be implemented as one or more routines embedded in the communications network, as a resource residing on a server, or the like. The various exemplary embodiments of the system for sharing high value information 40 and the various circuits or software routine or elements discussed above can also be implemented by physically incorporating the system for sharing high value information 40 into a software and/or hardware system, such as the hardware and software systems of a web server or a client device.

As shown in FIG. 2, the memory 42 and annotation storage memory 49 can be implemented using any appropriate combination of alterable, volatile or non-volatile memory or non-alterable, or fixed, memory. The alterable memory, whether volatile or non-volatile, can be implemented using any one or more of static or dynamic RAM, a floppy disk and disk drive, a write-able or rewrite-able optical disk and disk drive, a hard drive, flash memory or the like. Similarly, the non-alternable or fixed memory can be implemented using any one or more of ROM, PROM, EPROM, EEPROM, an optical ROM disk, such as a CD-ROM or DVD-ROM disk, and disk drive or the like.

The communication links 110 shown in FIGS. 1 and 2 can each be any known or later-developed device or system for connecting a communication device to the system for sharing high value information 40, including a direct cable connection, a connection over a wide area network or a local area network, a connection over an intranet, a connection over the Internet, or a connection over any other distributed processing network or system. In general, the communication links 110 can be any known or later-developed connection system or structure usable to connect devices and facilitate communication

Further, it should be appreciated that the communication links 110 can be a wired or wireless links to a network. The network can be a local area network, a wide area network, an intranet, the Internet, or any know or later-developed other distributed processing and storage network.

While this invention has been described in conjunction with the exemplary embodiments outlines above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope of the invention.

What is claimed is:

1. A method for sharing high value annotations associated with a contextually relevant portion of a document comprising the steps of:
determining at least one high value annotation associated with a contextually relevant portion of a document to display;
determining a presentation style for the at least one high value annotation;
displaying the high value annotations based on the determined presentation style and maintaining the association with the contextually relevant portion of the document.

2. The method of claim 1, wherein the presentation style is selectively overlaying at least two high value annotations.

3. The method of claim 2, wherein selectively overlaying the high value annotations comprises resolving overlapping high value annotations by modifying a first display characteristic of the high value annotations.

4. The method of claim 3, wherein the first display characteristic of the high value annotations is at least one of re-scaling, re-positioning and re-sizing.

5. The method of claim 3, wherein a second display characteristic of the high value annotations is modified based on at least one of user, time of annotation, importance.

6. The method of claim 1, wherein the presentation style is generating an emphasis icon for the at least one high value annotation.

7. The method of claim 6, wherein generating an emphasis icon comprises generating a number of graphic elements making up the emphasis icon based on the importance of the high value annotation.

8. The method of claim 7, wherein a second display characteristic of the high value annotations is modified based on at least one of user, time of annotation, importance.

9. The method of claim 1, wherein the presentation style is relative scaling of the high value annotations.

10. The method of claim 9, further comprising the steps of:
determining a display element from at least one of a contextually relevant portion of a document and a high value annotation;
scaling the determined display element while maintaining the associated contextual relevance.

11. The method of claim 10, wherein
The determined display element is at least one of a contextually relevant portion of a document and a high value annotation.

12. A system for sharing high value annotations associated with a contextually relevant portion of a document comprising:
a controller;
a high value determining circuit for determining at least one high value annotation associated with a contextually relevant portion of a document to display;
a memory for storing a presentation style for the at least one high value annotation;
a annotation display attribute modifying circuit for modifying a display attribute of the high value annotations based on the stored presentation style and maintaining the association with the contextually relevant portion of the document.

13. The system of claim 12, wherein the presentation style is selectively overlaying at least two high value annotations.

14. The system of claim 13, wherein selectively overlaying the high value annotations comprises resolving overlapping high value annotations by modifying a first display characteristic of the high value annotations.

15. The system of claim 14, wherein the first display characteristic of the high value annotations is at least one of re-scaling, re-positioning and re-sizing.

16. The system of claim 14, wherein a second display characteristic of the high value annotations is modified based on at least one of user, time of annotation, importance.

17. The system of claim 12, wherein the presentation style is generating an emphasis icon for the at least one high value annotation

18. The system of claim 17, wherein generating an emphasis icon comprises generating a number of graphic elements making up the emphasis icon based on the importance of the high value annotation.

19. The system of claim 18, wherein a second display characteristic of the high value annotations is modified based on at least one of user, time of annotation, importance.

20. The system of claim 12, wherein the presentation style is relative
scaling of the high value annotations.

21. The system of claim 20, further comprising
determining a display element from at least one of a contextually relevant portion of a document and a high value annotation;
scaling the determined display element while maintaining the associated contextual relevance.

22. The system of claim 10, wherein the determined display element is at least one of a contextually relevant portion of a document and a high value annotation.
